(19) United States
(12) Patent Application Publication
(10) Pub. No.: US 2013/0262066 A1
(43) Pub. Date: Oct. 3, 2013

(54) System and Method for Analyzing Engagement Surfaces Between Tools and Workpieces During Machining Simulation

(71) Applicants: Huseyin Erdim, Somerville, MA (US); Alan Sullivan, Middleton, MA (US)

(72) Inventors: Huseyin Erdim, Somerville, MA (US); Alan Sullivan, Middleton, MA (US)

(21) Appl. No.: 13/434,407

(22) Filed: Mar. 29, 2012

(51) Int. Cl. G06G 7/48

(52) U.S. Cl. 703/7

(57) ABSTRACT

A method determines an engagement surface between a tool and a workpiece during a simulation of a machining of the workpiece by a relative motion between the object and the tool. A set of points is arranged on at least a part of a surface of the tool. A distance between each point in the set of points and a surface of the workpiece modified by the motion is determined and the engagement surface is formed based on a subset of points having the distance below a threshold.

### FIELD OF THE INVENTION

The invention relates generally to analyzing engagement surface between an object and a shape intersecting the object, and more particularly to determining an angle of engagement or an area of engagement between a tool and a workpiece during a simulation of a machining of the workpiece by a motion of the tool.

### BACKGROUND OF THE INVENTION

### NC Milling

Simulating the process of numerically controlled (NC) milling is of fundamental importance in computer aided design (CAD) and computer aided manufacturing (CAM). During simulation, a computer model of a workpiece is edited with a computer representation of an NC milling tool and a set of NC milling tool motions to simulate the milling process.

The workpiece model and tool representation can be visualized during the simulation to detect potential collisions between parts, such as the workpiece and the tool holder, and after the simulation to verify the final shape of the workpiece.

The final shape of the workpiece is affected by the selection of the tool and the tool motions. Instructions for controlling the motions are typically generated using the CAM system from a graphical representation of the desired final shape of the workpiece. The motions are typically implemented using numerical control programming language, also known as preparatory code or G-Codes, see, e.g., the RS274D and DIN 66025/ISO 6983 standards.

The G-Codes generated by the CAM system may not produce an exact replication of the desired shape. In addition, the movement of the NC tool is governed by operational parts of the NC milling machine, which can have constrained speeds, ranges of motion, and abilities to accelerate and decelerate. Therefore, the actual tool motions may not exactly follow the NC machine instructions.

Discrepancies between the final shape of the workpiece and the desired shape of the workpiece may be very small. In some situations, these discrepancies can result in undesirable gouges or nicks in the surface of the final shape of the workpiece with sizes on the order of a few micrometers in depth and width, and tens of micrometers in length.

Typically, a set of NC machine instructions is tested by milling a test workpiece made of a softer, less expensive material prior to milling the desired part. If visual inspection of the test workpiece locates undesirable discrepancies in the test workpiece, the NC machine instructions can be modified accordingly.

This manual testing is time consuming and expensive. Time for machining a single test workpiece may be on the order of hours and several iterations may be required before an acceptable set of NC machine instructions is attained. Thus, it is desirable to test for these discrepancies using computer-based simulation and rendering. However, in order to detect discrepancies with dimensions on the order of a few micrometers for workpieces, which may have dimensions on the order of one meter, very precise computer models are required. It is an object of the present invention to provide a space and time efficient method for representing and rendering such high precision models for milling simulation.

Swept Volumes

During milling, the tool moves relative to the workpiece according to a prescribed tool motion, referred to herein as a tool path. The tool path can contain information about the relative position, orientation, and other shape data of the tool with respect to the workpiece.

As the tool moves along the tool path, the tool carves out a “swept volume.” During milling, as the tool moves along the tool path, a portion of the workpiece that is intersected by the swept volume is removed. This material removal can be modeled computationally as a constructive solid geometry (CSG) difference operation, in which the portion of the workpiece is removed from the workpiece using a CSG subtraction operation of the swept volume from the workpiece.

Although NC milling simulation is used as an example application, swept volumes have applications in many areas of science, engineering, entertainment, and computer graphics. Some specific applications include computer-aided design, freeform design, computer-based drawing, animation, solid modeling, robotics, manufacturing automation, and visualization to name but a few. The following description applies to all areas where an accurate representation of a swept volume is required, or desired.

Although this description focuses on three-dimensional coordinate systems, the term ‘swept volume’ can be extended more generally to N-dimensional coordinate systems. In particular, the following description also applies to areas swept out by a one-dimensional or two-dimensional shape moving along a path in a two-dimensional space, or to a hyper-volume swept out by a shape moving over a path or surface in higher dimensional systems.

An overview of the importance and challenges in swept volume research is presented by Abdel-Malek, Blackmore, and Joy in “Swept Volumes: Foundations, Perspectives, and Applications”, International Journal of Shape Modeling, 2006. They conclude that research in this field is limited by the difficulty of implementing complex mathematical formulations of swept volumes using software, and that computing the boundaries of swept volumes remains a challenging problem requiring better visualization tools and more accurate methods.

The swept volumes of simple shapes moving along simple paths can sometimes be represented analytically, as described in U.S. Pat. No. 4,833,617. However, those methods do not generalize to complex shapes and complex tool paths.

Several methods approximate the swept volumes of polygonal shapes. Models of polygonal shapes can be encoded in a spatial hierarchy for efficient editing via CSG operations as in “Interactive CSG” Proceedings, Technical Sketches, SIGGRAPH, 1999, Butcher, or for efficient collision detection as in U.S. Pat. No. 6,099,573. A method for approximating the swept volume of a polygonal object is also described in “Computing Swept Volumes”, Journal of Visualization and Animation, 2000, Abrams and Allen.

U.S. Pat. No. 6,862,560 describes a method for simulating machining using CSG operations on polygonal models of swept volumes. In that method, the boundary of the workpiece is encased in a set of cells, where each cell includes references to swept volume polygons that intersect the cell. Intersections between the workpiece and the swept volume polygons within a particular cell can be processed, on demand, to generate a high precision rendering of the milled surface for a small region of interest. However, visualizing the full model at high precision is extremely time consuming.

U.S. Pat. No. 6,993,461 describes representing an object as a polyhedron. The object is placed along the path at discrete time steps using a series of transformations. Edges and faces of the polyhedral representation that are on the boundary of the swept volume are determined at each time step and connected to each other to generate a polyhedral approximation of the swept volume.

The accuracy of each of those polygonal methods is limited by the polygonal representation of the object model. Billions of polygons may be required to accurately represent the curved surface of a complex tool, especially if the radius of curvature is small. Thus, those methods may either have limited accuracy or have prohibitive processing times and memory requirements for generating high precision models of swept volumes, or both. In addition, methods that approximate the swept volume as a series of discrete time steps have limited precision between the discrete time steps, and are subject to aliasing artifacts.

Another common representation for milling simulation is known as the Z-buffer or a Dexel method. That method is described in “Real-time Shaded NC Milling Display”, Proceedings, SIGGRAPH 1986, van Hook. U.S. Pat. No. 7,149,668 describes a similar method in which the workpiece is modeled by a grid of straight lines all in the z-direction, and the milling simulation is performed by moving the tool model over the grid and modifying the height of the lines representing the workpiece that are intersected by the tool.

The Dexel method typically suffers from limited resolution, especially in directions not aligned with the z-axis, and is not suitable for generating high precision models of swept volumes. The Dexel representation is related to voxel-based representations. In “Volume Visualization”, IEEE Computer Society Press, 1991, Kaufman describes voxel-based representations as well as methods for rendering and processing voxel-based representations. “Sculpting: an Interactive Volumetric Modeling Technique”, Proceedings, SIGGRAPH 1991 Galyean and Hughes, and “Volume Sculpting: Proceedings, SIGGRAPH 1995, Wang and Kaufman, both simulate sculpting using CSG operations on voxel-based representations of objects.

Methods that use binary voxels to represent swept volumes are described in U.S. Pat. No. 6,044,306, and “Method and Apparatus for Shaping Geometric Shapes” and “Octree-based Boundary Evaluation for General Sweeps”, Proceedings, TIME, 2008 Erdim and Ilies. The accuracy of those methods is limited by the size of the smallest voxel used to represent the swept volumes.

Distance Fields

Distance fields are an effective representation for rendering and editing shapes, as described in U.S. Pat. Nos. 6,396,492, 6,724,393, 6,826,024, and 7,042,458.

Distance fields are a form of implicit functions that represent an object. A distance field is a scalar field that gives a shortest distance to the surface of the object from any point in space. A point at which the distance field is zero is on the surface of the object. The set of points on the surface of the object collectively describe the boundary of the object, also known as the d=0 isosurface. The distance field of an object is positive for points inside the object, and a negative for points outside the object.

Distance fields have been used to represent and render swept volumes. “Sweeping of Three Dimensional Objects”, Computer Aided Design, 20(4), 1990, Martin and Stephenson, described a theoretical foundation for defining the envelope of a swept volume in terms of an implicit function. In “Function Representation for Sweeping by a Moving Solid”, Proceedings, Solid Modeling, 1995, Sourin and Pasko represented swept volumes using implicit surfaces. However, implicit surfaces can be difficult to render, and a suitable implicit representation for an arbitrarily complex tool shape is difficult to define.

A procedure for computing the distance field of an object is called a distance field function. For very simple objects, such as a plane, a sphere or a cylinder, the distance field function can be an analytic function with a closed form. For more complex objects the analytic function may impossible. However, a numerical procedure can still be possible. For example, U.S. Pat. No. 2010/0298967 describes a numerical procedure for determining the distance field of a swept object, such as a swept milling tool.

Adaptively sampled distance fields (ADFs) use detail-directed sampling to provide a much more space and time efficient representation of distance fields than is obtained using regularly sampled distance fields. ADFs store the distance field as a spatial hierarchy of cells. Each cell contains distance data and a reconstruction method for reconstructing a portion of the distance field associated with the cell. Distance data can include the value of the distance field, as well as the gradient and partial derivatives of the distance field. The distance field within a cell can be reconstructed only when needed to reduce memory and computational complexity.

ADFs can be used to simulate editing using CSG operations. The model to be edited and the editing tool can be represented as distance functions, regularly sampled distance fields, or ADFs. The editing process can generate the ADF of the edited shape explicitly, for example by modifying the ADF of the model.

Alternatively, the edited shape can be represented implicitly as a composite ADF (CADF). The CADF is generated to represent the object, where the CADF includes a set of cells arranged in the spatial hierarchy. Each cell in the CADF includes a subset of the set of geometric element distance field functions and a reconstruction method for combining the subset of geometric element distance field functions to reconstruct a composite distance field of a portion of the object represented by the cell. Each distance field in the subset of distance fields forms a part of the boundary of the object within the cell, called the composite boundary.

CADFs can reconstruct the distance field of a milled object with a very high accuracy. The distance field function of the set of geometric elements can be computed with high accuracy by analytic or numerical methods, and values of the distance field functions can be combined with high accuracy. The resulting surface is very detailed with surface features that may be smaller than 1 micron for a simulated object that is about one cubic meter.

Tool Workpiece Engagement

During milling, as the tool moves along the tool path, the tool is in contact with the workpiece over a common surface which is called an “engagement surface.” As the tool moves relative to the workpiece, the tool carves out the swept volume. A portion of the workpiece that is intersected by the swept volume is removed, and called as “removed volume.” The workpiece that is updated by the removed volume is called an “in-process workpiece.” The engagement surface is the result of an intersection Boolean operation that occurs between the tool and the in-process workpiece.

The simulation of the milling operation requires accurate high precision geometric modeling of the material removed by the milling tool. To model the process mechanics and dynamics accurately, it is necessary to have a precise geometric representation of the engagement surface.

The basic input to NC milling process simulation is the geometry of engagement surface that occurs between the tool and workpiece. The geometry of the engagement surface can have multiple disconnected sub-surfaces. It is through this engagement surface that the milling forces are applied between the tool and the workpiece. Mechanistic modeling can be used to predict the milling forces, bending moment, spindle torque, spindle power, and tool defections from the instantaneous engagement surface and other parameters such as axial and radial depths, tool thickness, and errors of the surfaces due to tool deflections, parameters defining tool geometry, and milling parameters.

Although NC milling simulation is used as an example herein, tool workpiece engagement occurs in many problems of design, kinematics, manufacturing, and robotics. Some specific practical applications include moving mechanical parts such as kinematic pairs, frictional contact between sliding parts, robotics, and tool path generation to name a few. The following description applies to all areas where an accurate representation of a swept volume is required or desired.

One of the fundamental difficulties has been the accurate and computationally efficient determination of the engagement surface along the tool path. The determination of the engagement surface is challenging due to complicated and changing tool workpiece intersection during NC milling. The geometric properties of the engagement surface comprise angle, area, orientation, curvature, shape, and etc., at any time instance.

Numerous methods of determining the engagement surface are known. For example, boundary representation (B-rep) based milling simulation can analytically compute the engagement surface for simple milling tools, and 2.5 axis tool paths. See, Yip-Hoi and Huang: “Cutter/Workpiece Engagement Feature Extraction from Solid Models for End Milling,” ASME Journal of Manufacturing Science and Engineering, 2006, and Spence and Altintas: “A Solid Modeller Based Milling Process Simulation and Planning System,” Journal of Engineering for Industry, 1994. Both of these methods simulate the milling by a flat-end mill tool, and determine the engagement surface by a B-rep based solution. However, those methods are impractical for complex milling tools and tool paths due to complexity of computation and inconsistency of the results.

To reduce the computational complexity and to avoid problems related to CSG and B-rep based methods, image space methods, which are approximate in nature, have been used to compute tool and workpiece engagements. However, those methods are unable to supply accurately the information about in-process workpiece required for computing tool workpiece engagements. For example, those methods avoid the computationally complex direct Boolean operations to implement a fast simulation. However, accuracy is a major concern for milling simulation.

Several methods approximate the swept and removed volumes of the milling tool by polygonal shapes. Those methods include Aras and Yip-Hoi: “Geometric Modeling of Cutter/Workpiece Engagements in Three-Axis Milling Using Polyhedral Representations,” ASME Journal of Computing and Information Science in Engineering, 2008, and Yao: “Finding Cutter Engagement for Ball End Milling of Tessellated Free-Form Surfaces,” ASME IDETC/CIE 2005. The accuracy of polygonal-based methods is limited by the polygonal representation of the object model. However, billions of polygons may be required to accurately represent the curved surface and removed volume of a complex tool, especially if the radius of curvature is small. Thus, those methods either have limited accuracy or they have prohibitive processing times and memory requirements for calculating high precision tool workpiece intersection properties.

Another method for determination of the engagement surface is Z-buffer or Dexel method. See, Chappel: “The use of vectors to simulate material removed by numerically controlled milling” Computer-Aided Design, 1983. Dexel methods typically suffer from limited resolution, especially in directions not aligned with the z-axis, and are not suitable for generating high precision models of in-process workpiece. Although accuracy is improved by increasing the resolution of the underlying grid, this comes with the expense of larger memory and computational requirements.

Another method combines different representations. A semi discrete solid modeling based approach is described by Ferry and Yip-Hoi: “Cutter-Workpiece Engagement Calculations by Parallel Slicing for Five-Axis Flank Milling of Jet Engine Impellers”, ASME Journal of Manufacturing Science and Engineering, 2008. The removed volume is sliced into a number of parallel planes along the intermediate axis of the two consecutive cutter locations to form the engagement polygon between the cutter and workpiece. The main drawback of these methods is the computation time, where determining the optimum number of slices is difficult.

Thus there is a need for a method for determining with an engagement surface between an arbitrary tool moving along an arbitrary tool path and a workpiece. Additionally, there is a need for a method for determining the angle and area of the engagement surface to improve the accuracy of mechanistic modeling.

### SUMMARY OF THE INVENTION

It is an object of various embodiments of an invention to analyze an engagement of between a tool and a workpiece during a simulation of machining of the workpiece by a motion of the tool according to a path. In some embodiments, the workpiece is represented by a model of the workpiece including an object distance field defining a surface of the workpiece. The tool is represented by a model of the tool including a tool distance field defining a surface of the tool. The motion is represented by at least one swept volume including a swept volume distance field defining a surface of the swept volume. The path is represented by a parametric function.

In the embodiments using analytical representation of surfaces of tools and workpiece during the simulation, the task of determining the engagement surface is difficult due to a lack of actual representation of the surfaces. Various embodiments of the invention are based on a general realization that it is possible to determine the engagement surface based on distances between the surfaces, which is advantageous for available analytical representation. Specifically, it is realized that an engagement surface formed by the tool intersecting the workpiece at a instant of the simulation can be determined based on distance values between a set of points arranged on the surface of the tool and a surface of an in-process workpiece defined by the object distance field modified by the swept volume distance field at the instant of the simulation.

Accordingly, one embodiment of the invention discloses a method for determining an engagement surface between the tool and the workpiece during the simulation of a machining of the workpiece by a motion of the tool. The method includes arranging a set of points on at least a part of a surface of the tool; determining a distance between each point in the set of points and a surface of the workpiece modified by the motion; and forming the engagement surface based on a subset of points having the distance below a threshold. The steps of the method are performed by a processor.

Another embodiment of the invention discloses a method for determining an engagement between a tool and an object during a simulation of a machining of the object by a motion of the tool, wherein the object is represented by an object distance field, the tool is represented by a tool distance field, and the motion is represented by a swept volume distance field. The method includes arranging a set of points on at least a part of the surface of the tool using the tool distance field; determining a distance between each point in the set of points and the surface of the object modified by the swept volume using at least one of the object, tool, or the swept volume distance field; and forming the engagement surface based on a subset of points having the distance below a threshold, wherein the steps of the method are performed by a processor.

Yet another embodiment discloses a system for analyzing an engagement between a tool and a workpiece during a simulation of a machining of the workpiece by a motion of the tool according to a path, wherein the workpiece is represented by a model of the workpiece including an object distance field defining a surface of the workpiece, the tool is represented by a model of the tool including a tool distance field defining a surface of the tool, and the motion is represented by at least one swept volume including a swept volume distance field defining a surface of the swept volume, the path is represented by a parametric function.

The system includes a processor for determining an engagement surface farmed by the tool intersecting the workpiece at a instant of the simulation based on distance values between a set of points arranged on the surface of the tool and a surface of an in-process workpiece defined by the object distance field modified by the swept volume distance field at the instant of the simulation.

The engagement surface determination method is used to incorporate high precision angles of engagement into modeling of machining forces. The engagement surface is approximated by points which represent the thin strips to enable direct input to the physical force models for milling. Additionally angle and area of engagement are used for machining process analysis; calculation of machining forces, uncut chip thickness, spindle torque, power, axial and radial depth of cuts, tool deflection and surface form errors due to tool deflections.

### BRIEF DESCRIPTION OF THE DRAWINGS

FIG. 1 is a flow diagram of an NC milling machine and a system and method for simulating NC milling according to embodiments of the invention;

FIG. 2A is a diagram of exemplar tools used for milling and exemplar edits on a workpiece made by moving tools along a path;

FIG. 2B is a schematic of a swept volume determined by sweeping a 2D shape along a curved path;

FIG. 3A is a schematic of a linear path of a tool;

FIG. 3B is a diagram of an arc path of a tool in which the tool axis changes along the path;

FIG. 3C is a schematic of a curve path of a tool;

FIG. 4A is a diagram of tool instances for a tool path;

FIGS. 4B and 4C are diagrams of method for determining a removed volume, in-process workpiece and engagement surface between a tool and in-process workpiece according to embodiments of an invention;

FIG. 4D is a perspective view showing the engagement surface and angle of engagement on the tool boundary;

FIG. 4E is a top view corresponding to FIG. 4D;

FIG. 4F is a flow diagram of a method for analyzing an engagement between the tool and the workpiece during a simulation of a machining according to some embodiments of the invention;

FIG. 5 is a flow diagram of method for simulating milling of a workpiece with a tool shape using a set of G-Codes or NC machine instructions according to an embodiment of the invention;

FIG. 6 is a flow diagram of a method for reconstructing a distance field of a swept volume of a shape at a sample point;

FIG. 7 is a flow diagram of a method for determining an engagement surface between a tool and an in-process workpiece;

FIG. 8 is a flow diagram of a method for determining the angle and area of engagement between the in-process workpiece and the tool;

FIGS. 9A and 9B are diagrams of sampled points on a surface of exemplar set of cylindrically symmetric tools and corresponding two dimensional cross sections;

FIG. 10A is a diagram of initial workpiece and a flat-end mill tool;

FIG. 10B is a diagram of in-process workpiece and tool instance showing a state of milling performed by the flat-end mill tool;

FIG. 10C is a diagram of tool instance and points corresponding to the engagement surface; and

FIG. 10D is the top view corresponding to FIG. 10A for different depth of cuts with the angle of engagement.

### DETAILED DESCRIPTION OF THE PREFERRED EMBODIMENT

System and Method Overview

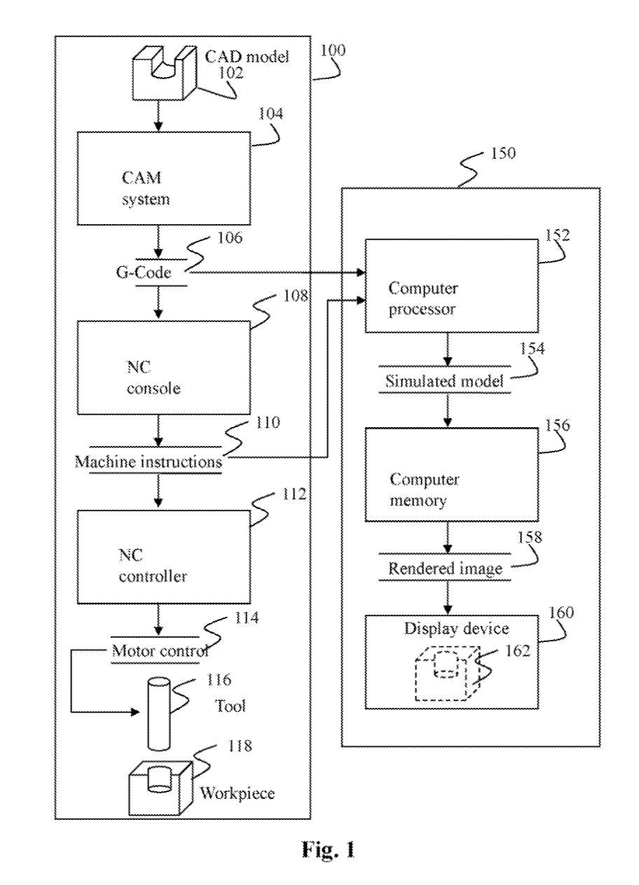

FIG. 1 shows an NC milling system 100, and a numerically controlled (NC) milling simulation system 150. In the NC milling system 100, a computer aided design (CAD) model 102 is input to a computer aided manufacturing (CAM) system 104, which generates G-Codes 106 for controlling an NC milling machine. During NC milling, the G-Codes are input to an NC milling input interface 108, which processes each G-Code to produce a corresponding set of NC machine instructions 110. The NC machine instructions are input into an NC controller 112, which produces a set of motor control signals 114 to move a tool 116 relative to a workpiece 118 in order to mill the workpiece.

The simulation system 150 can take as input either the G-Codes 106 generated by the computer aided manufacturing system 104, or the NC machine instructions 110 generated by the NC console 108. The input to the simulation system is read by a computer processor 152, which simulates machining of the workpiece, and outputs a simulated model 154, which can be stored in a computer memory 156. The processor 152 can render the stored simulated model 154 to generate a rendered image 158 which can be output to a display device 160. A displayed image 162 can be compared to the computer aided design model 102 to verify the G-Codes 106 or NC machine instructions 110 prior to performing the actual NC milling of the workpiece.

Tools

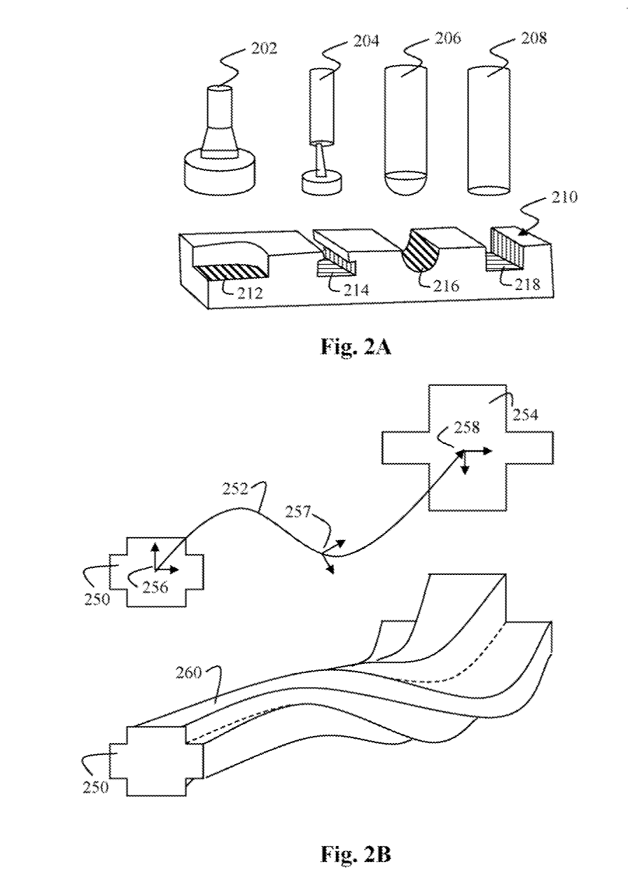

FIG. 2A shows a set of typical tool shapes 202, 204, 206, and 208 used in NC milling. When a tool is moved relative to a workpiece 210, the tool removes material from the workpiece. Here, the tools 202, 204, 206, and 208 remove material corresponding to surfaces 212, 214, 216, and 218 from the workpiece. The shape of the material removed by each tool is determined by the tool shape and the path of the tool relative to the workpiece. The shape of the material removed is the intersection of the workpiece and the swept volume of the tool as the tool moves along the path.

Although we focus here on NC milling simulation, swept volumes have applications in many areas of science, engineering, and computer graphics including computer-aided design, freeform design, solid modeling, robotics, manufacturing automation, and visualization.

Swept Volume

FIG. 2B shows the swept volume 260 of a shape 250 that is moved along a path 252. The path 252 specifies a position of a particular point of the shape 250 as a function of time. The path can specify an orientation 256, 257, and 258 of the shape as a function of time. The path can also specify a scale of the shape or an arbitrary transformation of the shape as a function of time. In FIG. 2B, the original position, orientation, and geometry of a shape 250 is transformed to a final position, orientation, and geometry of the shape 254 as it moves along the path.

Tool Paths

The path of the tool relative to the workpiece can be specified in many forms.

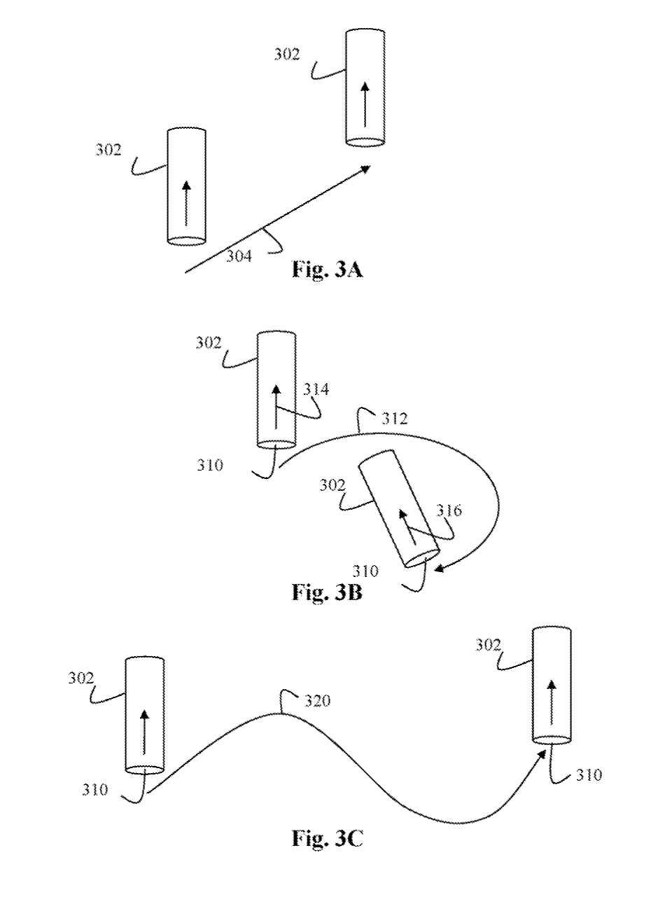

FIG. 3A shows a linear path, in which a tool 302 is moved along a straight line 304.

FIG. 3B shows a circular arc path, in which a tip 310 of the tool 302 is moved along a circular arc 312, and an original axis direction 314 of the tool is transformed to a final axis direction 316 at the end of the path.

FIG. 3C illustrates a curved path, in which the tip 310 of the tool 302 is moved along a curve 320.

Other possible path forms include positioning the tool at a point, moving the tool along a sequence of lines known as a polyline, moving the tool along a spiral or helical curve, moving the tool along a polynomial curve, such as a quadratic Bezier curve or a cubic Bezier curve, or a sequence of polynomial curves known as a piecewise polynomial curve to name but a few. Any form of path that can be simulated can be considered, including a path defined by a procedure such as a path that is influenced by the shape or material composition of the workpiece.

Engagement Between Tool and Workpiece During Simulation

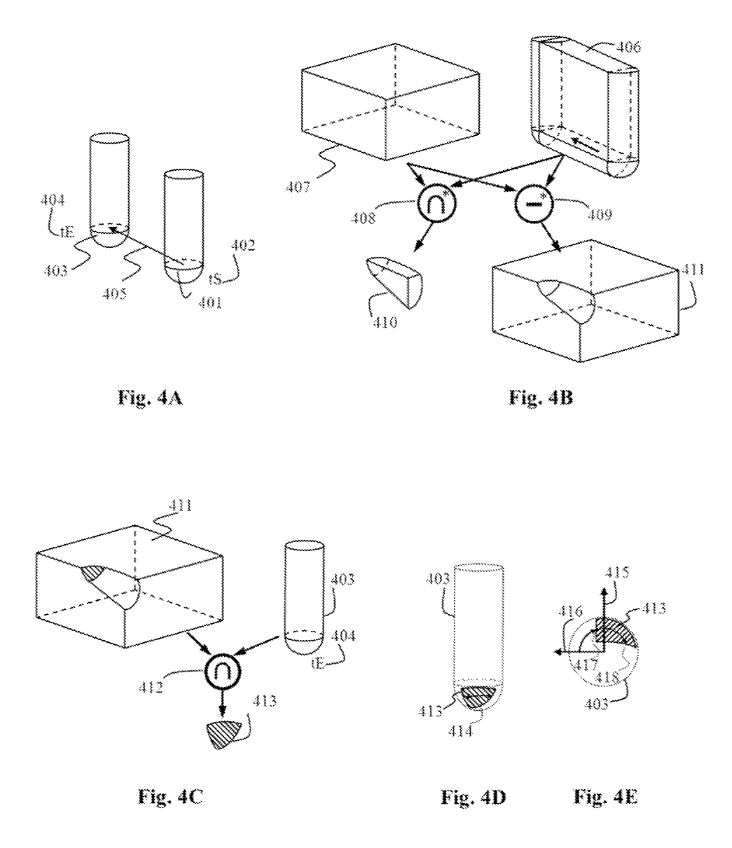

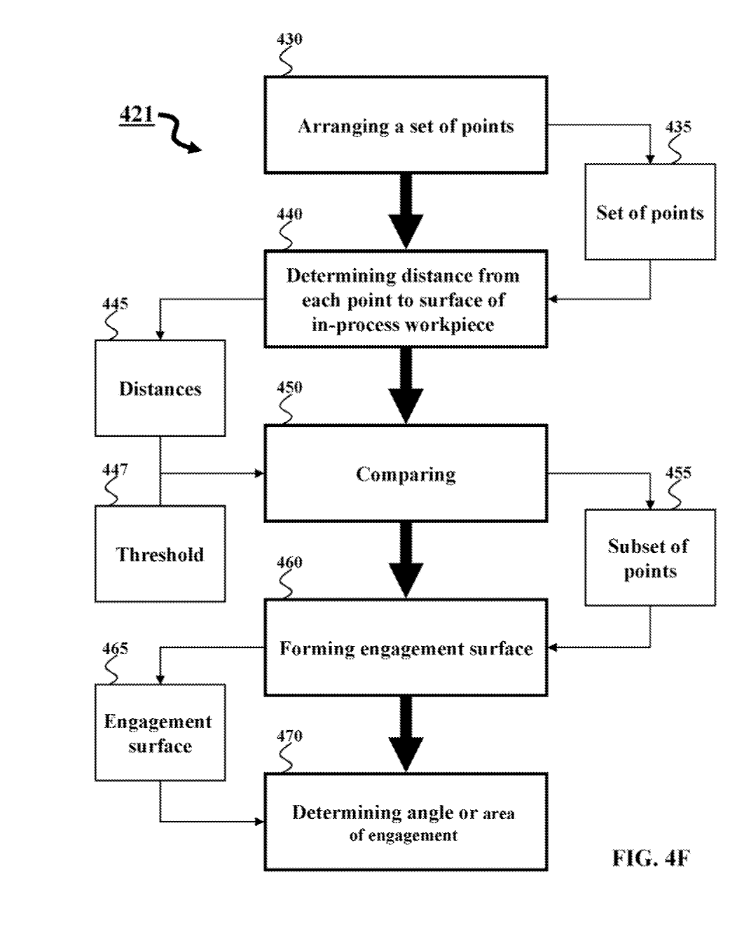

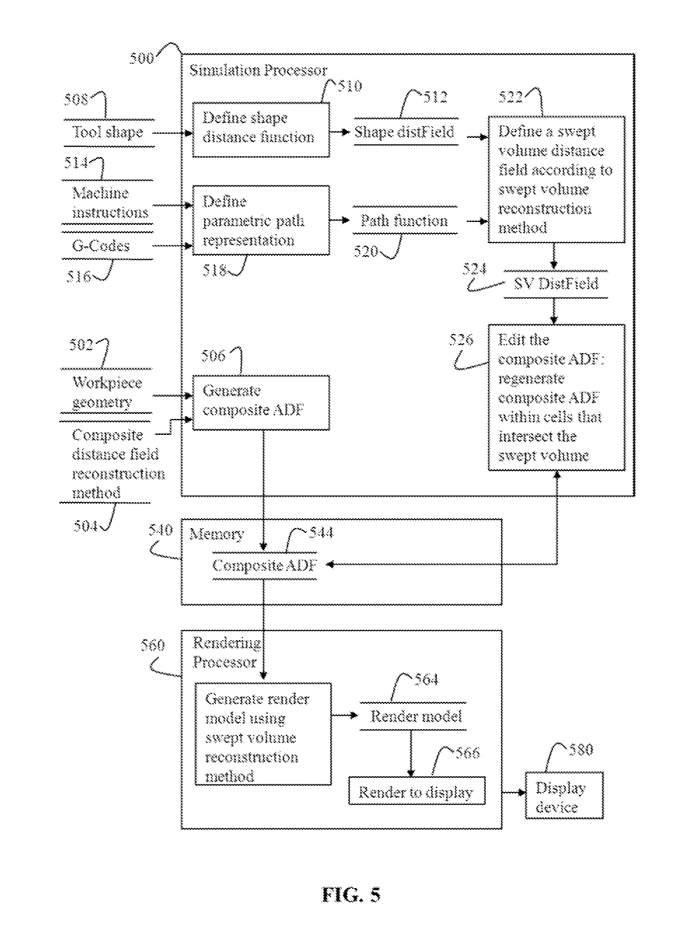

FIGS. 4A-E shows an engagement surface between a model of a tool and an in-process model of a workpiece, i.e., tool workpiece engagement surface (TWES), determined during milling simulation according to an embodiment of the invention.

FIG. 4A shows a linear toolpath, in which a model of a milling tool at start time tS 402 is moved from initial position 401 of the tool path to a current position 403 of tool path at a time tE 404 along a straight line 405 resulting in a swept volume 406.

FIG. 4B shows the generation of in-process workpiece 411 and removed volume 410 by performing regularized Boolean intersection 408 and regularized Boolean difference operations 409 between the workpiece 407 and swept volume 406 according to a prescribed tool motion. Regularized Boolean operations ensure that the pair of solids always combines to yield solids.

FIG. 4C shows the engagement surface 413 which is determined by intersection operation 412 between the in-process workpiece 411 and the tool in the position 403 at the time tE 404. This engagement surface defines the instantaneous intersection surface between the model of the tool and the in-process workpiece at each location along the tool path. As used herein, the engagement surface is the instantaneous contact surface between a model of the tool and a model of the in-process workpiece during machining, e.g., a milling simulation.

FIG. 4D shows the engagement surface 413 on the boundary of the tool in the position 403. The angle of engagement 414 is calculated by using the determined engagement surface 413.

FIG. 4E shows the top view corresponding to tool and engagement surface given in FIG. 4D. Angle of engagement can be measured from the normal vector 416 perpendicular to tangent tool path vector 415. The entry angle 417 is the angle at which the tool enters the workpiece, and exit angle 418 is the angle at which the tool leaves the workpiece. The angle of engagement is basically the region between the exit and entry angles where the tool actually removes material and creates milling forces.

FIG. 4F is a block diagram of a method for analyzing an engagement between the tool and the workpiece during a simulation of a machining according to some embodiments of the invention. In various embodiments, the workpiece is represented by a model of the workpiece including an object distance field defining a surface of the workpiece, the tool is represented by a model of the tool including a tool distance field defining a surface of the tool, and the motion is represented by at least one swept volume including a swept volume distance field defining a surface of the swept volume, as described in more details below. Steps of the method can be implemented using a processor 421.

A set of points 435 is arranged 430 on at least a part of a surface of the tool. In various embodiments the set of points is arranged according to a sampling pattern, as described in more details below. Also, in some embodiments, the set of points are arranged using various techniques of software engineering and computer graphics. For example, in one embodiment the set of points is arranged using a separate data vector storing a number and location of the points. This data vector is later removed after the engagement surface is determined. In another embodiment, the set of points is arranged in real time of simulation without creating a separate data structure.

For each point in the set, a distance 445 between a point and a surface of the workpiece modified by the motion is determined 440, and compared 450 with a threshold 447 to determine a subset of points 455 forming 460 an engagement surface 465. For example, the engagement surface is formed based on the subset of points having the distance below the threshold. Next, in some embodiments, an area and an angle of engagement between the tool and the workpiece are determined 470 based on the engagement surface 465.

Milling Simulation

FIG. 5 shows a method for simulating milling of a workpiece with a tool shape using a simulation processor 500, storing a representation of the milled workpiece in a memory 540, and rendering the representation of the milled workpiece using a rendering processor 560 to a display device 580. The simulation of the milling is provided for illustration purposes only. Various embodiments use various types of machining simulation, such as drilling, milling, etc. The workpiece can be any object subjected to the simulation.

A workpiece shape and a method for reconstructing a composite distance field from a set of distance fields 504 are used to generate a composite ADF 544, which may be stored in the memory 540. The workpiece shape is specified by workpiece geometry 502, which comprises a set of geometric elements.

Each geometric element of the workpiece geometry is converted to a distance field representation, specifying a set of geometric element distance fields. Each geometric element distance field can be represented as one of an analytic distance function; an implicit distance function, a regularly sampled distance field, an ADF, a composition of distance functions, or a procedure, to name but a few.

In one embodiment, the composite ADF is stored in a memory as an octree, which is generated in a top down manner starting with a root cell enclosing a bounding box of the workpiece shape. A distance field representation of each particular geometric element in the workpiece geometry 502, is added to leaf cells of the composite ADF whose distance fields are influenced by the particular geometric element. During rendering and processing, the distance field of a particular leaf cell can be reconstructed at a sample point by combining the distance fields within the leaf cell using the composite distance field reconstruction method 504.

A variety of combining methods are possible and known in the art. In one embodiment, the combining uses a Boolean subtraction operator to simulate removal of material from the workpiece by the volume swept by the tool.

During ADF generation, leaf cells containing more than a specified maximum number of distance fields are subdivided to limit the complexity of the distance field within each leaf cell. Thus, composite ADFs are detail directed; larger cells occur in regions of the workpiece that are influenced by fewer distance fields and smaller cells occur in regions of the workpiece that are influenced by many distance fields.

The milling simulation method defines 510 a shape distance field 512 from a tool shape 508, where the shape distance field 512 can be one of an analytic distance function, an implicit distance function, a regularly sampled distance field, an ADF, a composition of distance functions, or a procedure, to name but a few.

An NC machine instruction 514, or alternatively, a G-Code 516, is used to define a parametric path function 520 corresponding to motion of the tool. For each tool motion, the shape distance field 512 and the parametric path function 520 are used to define 522 a swept volume distance field 524 representing the swept volume of the tool corresponding to the tool motion.

The composite ADF 544 is edited 526 with the swept volume distance field 524 to simulating milling of the workpiece with the tool motion. During editing, the swept volume distance field is added to cells of the composite ADF that are intersected by the swept volume of the tool, causing a regeneration of the ADF within the intersected cells.

The composite ADF can be used to generate 562 a render model 564, consisting of render model elements, and rendered 566 to the display device 580. Rendering methods known to the art, such as point rendering, triangle rendering, and ray tracing, can be used to generate and render the render model 564.

Distance fields have numerous advantages in physical simulation. An alternative embodiment for milling simulation uses distance fields to verify the NC milling process. For example, the composite ADF 544 generated by the milling simulator 500 can be compared to a distance field representation of the computer aided design model 102. The comparison can be made by visual inspection using the display device, 580.

Reconstructing a Distance Field of a Swept Volume

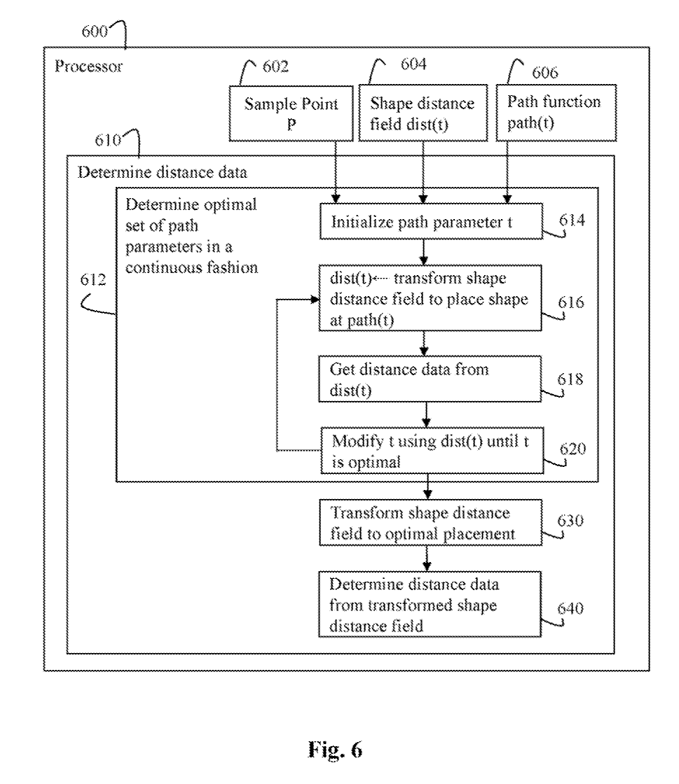

FIG. 6 shows a method for reconstructing a distance field of a swept volume at a sample instant of the simulation using a processor 600. A shape distance field 604 and parametric path function 606 specify a tool and a tool motion as described above. Given a sample point 602, a swept volume reconstruction method 610 determines distance data at the sample point 602 to reconstruct the distance field at the sample point. The method can determine 612, in a “continuous manner,” an optimal placement of the tool along the path.

During the determination of the optimal set of parameters 612, an initial set of parameters defining an initial placement of the tool shape along the path is selected. In one embodiment, the path is parameterized by a single parameter t, which corresponds to time traveled by the tool along the path, and an initial value of t is selected 614. The shape distance field is transformed 616 to place the shape of the tool at the time t along the path and the shape distance field is reconstructed 618 at the sample point 602.

Distance data reconstructed at the sample point can include a distance from the sample point to the transformed shape, a gradient of the distance field, and a partial derivative of the distance field to name but a few.

The reconstructed distance data are used to iteratively modify 620 the parametric value t to move the shape along the path to a placement closer to the sampling point. The modification can be done in a continuous manner, i.e., the parameter t is modified iteratively by an arbitrary amount in a direction that improves the position of the shape along the path rather than by selecting t from a predefined set of discrete values. The modification is iterated until an optimal t has been determined, until the change in/between iterations is below some minimum change in t, or until a maximum number of iterations have occurred. Once the optimal t has been determined, the shape is transformed 630 to the corresponding optimal placement and distance data is reconstructed 640 from the transformed shape to determine 610 the distance data at the sample point 602.

The distance field can be used to measure certain geometric and physical properties of the material removed by each tool motion. In the present invention, for a particular tool motion, the engagement surface which is the intersection between the tool and the in-process workpiece is determined corresponding to the particular tool instance along tool path.

Determining Engagement Surface

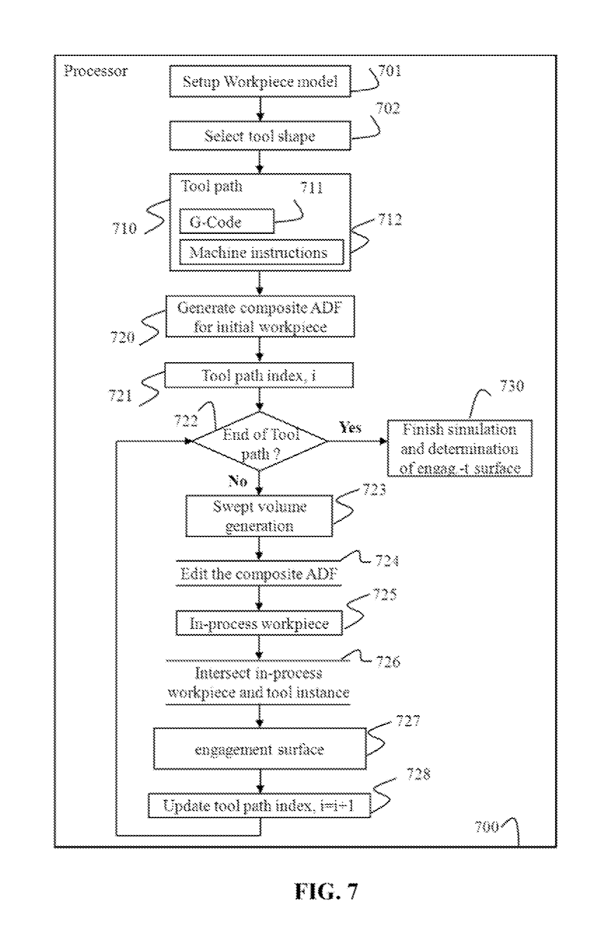

FIG. 7 shows a flow diagram of a method 700 for determining an engagement surface between a tool and an object during a simulation of a milling of the workpiece by a motion of the tool according to some embodiments of the invention. Various embodiments of the invention can use different steps of the method 700. In some embodiments, the workpiece is represented by a workpiece distance field, e.g., a composite ADF. Similarly, the tool can be represented by a tool distance field, and the motion can be represented by a swept volume (SV) distance field.

Given a workpiece model 701, a tool shape 702 and a tool path 710, the composite ADF is generated to reconstruct initial workpiece 720. The tool path index 721 is checked 722 if the current tool instance is the final instance of the tool path, or not. The composite ADF 723 is edited 724 with the swept volume distance field 723 to simulate the milling of the workpiece with the tool motion. During editing, the initial workpiece 720 is updated by the swept volume distance field to obtain in-process workpiece 725. The engagement surface 727 is determined by the intersection operation 726 between the in-process workpiece and tool instance. Some steps of the method 700 can be repeated iteratively 728.

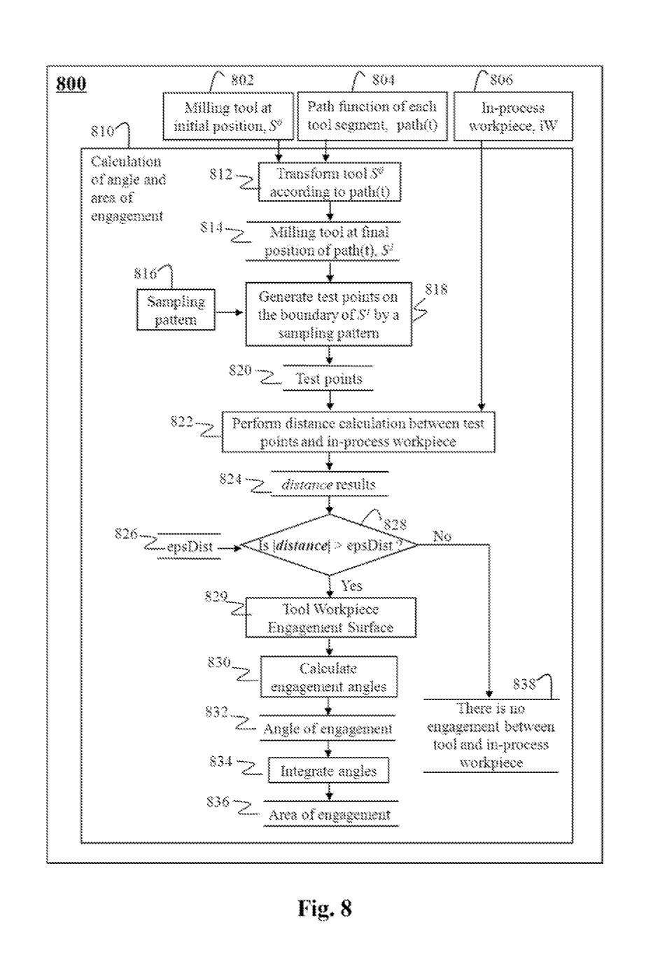

FIG. 8 shows a flow diagram of a method for determining the angle of engagement 832 and the area of engagement 836 using a processor 800. Given a tool 802 and the in-process workpiece 806 at any instance of simulation, and the corresponding tool path segment 804, the angle and the area of engagement between the tool and the in-process workpiece at given position is determined based on the engagement surface 829 corresponding to the instance of the simulation.

In one embodiment, the tool path segment is parameterized by a single parameter 1, which corresponds to time traveled by the tool along the path, and the tool 802 is transformed 812 to the end position of tool path segment 814.

Using a sampling pattern 816, test points 820 are determined on the boundary of tool 818. For each test point 820, a corresponding distance from the test point to the in-process workpiece 806 is calculated 822. The magnitude of the distance 824 is compared 828 to the predetermined maximum distance threshold, epsDist 826. If the absolute value of distance is greater than the maximum distance threshold, the test point is not on the boundary of in-process workpiece. If there are no test points on the boundary of the in-process workpiece, then there is no engagement between the tool and in-process workpiece 838.

If the absolute value of distance between the test point and in-process workpiece is less than the maximum distance threshold, the test point is on the boundary of the in-process workpiece. The engagement angle 830 and area 834 are determined based on the distances of test points to the composite ADF. After all the test points have been processed, the angles of engagement 832 are determined. Next, the angles of engagement are integrated to calculate the area of engagement 836.

Various embodiments of the invention use different sampling pattern 816. In one embodiment, the sampling pattern, for example, is a set of regularly spaced points in a cylindrical coordinate system, wherein points are equally spaced in angle within equally space planes perpendicular to the tool axis. Alternately, the points can be described in a spherical coordinate system in which the points are equally spaced in azimuth angle within planes that are equally spaced in elevation angle.

In another embodiment, the sampling pattern is a geodesic pattern in which the curves follow through the boundary circumscribing a regular polyhedron with triangular faces such as tetrahedron, icosahedron or octahedron, and then the sample points are placed on the vertices of triangles. Some other embodiments use other hybrid, non-uniform, random sampling patterns such as Gaussian sampling, Poisson sampling, and etc. For example, the points are separated by a minimum distance on the boundary in Poisson sampling.

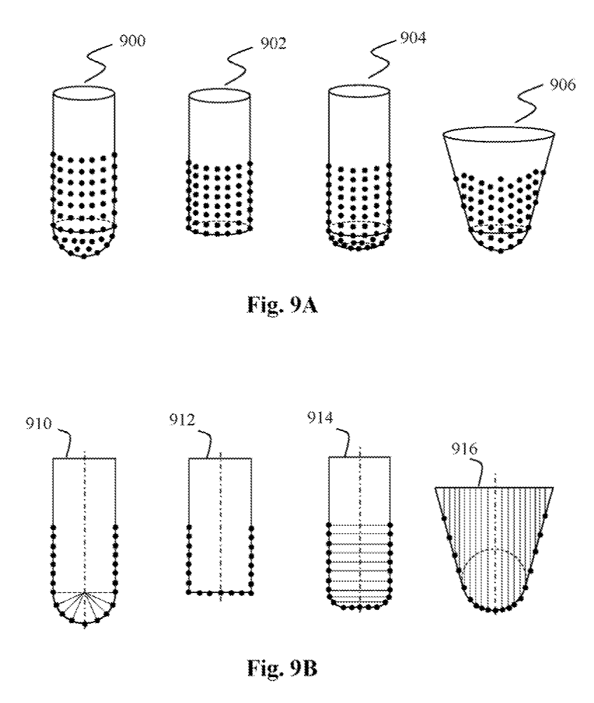

FIG. 9A shows a typical set of cylindrical tools 900, 902, 904 and 906 used for NC milling with exemplar points arranged on the surface of the tool according to some embodiments.

FIG. 9B shows the two dimensional cross-sections 910, 912, 914 and 916 of each tools 900, 902, 904 and 906 and sample points on their boundaries respectively.

Some embodiments select the sampling pattern based on the shape of the tool. For example, sampling the ball-end mill tool 900 with points in a cylindrical coordinate system is simple, but under-samples the regions close to the tip of the tool. Specifically, the points on the tip of the spherical part of the ball-end mill tool do not accurately represent the engagement surface. In contrast, points sampled in spherical coordinate system concentrate on the region close to the tip of the tool. However, such sampling is not always efficient because of the extra processing time required for additional points.

Some embodiments use a geodesic pattern as a sampling pattern for the spherical surface of a tool shape. Such geodesic pattern is advantageous, because the pattern is more uniformly distributed and more accurate than sampling in cylindrical or spherical coordinate system. Alternatively, some embodiments use a locally varying density of point samples to reduce over-sampling and under-sampling for general tool shapes.

In some embodiments, the engagement surface represents the geometric information necessary for milling force prediction in NC milling. Therefore, the accuracy of the prediction of the force depends on the accuracy of the angle of engagement determined based on the accuracy and the density of the sampling pattern. For example, when the depth of the tool along the tool path decreases, the contribution of the region close to the tool tip become more important than the case where the depth increases.

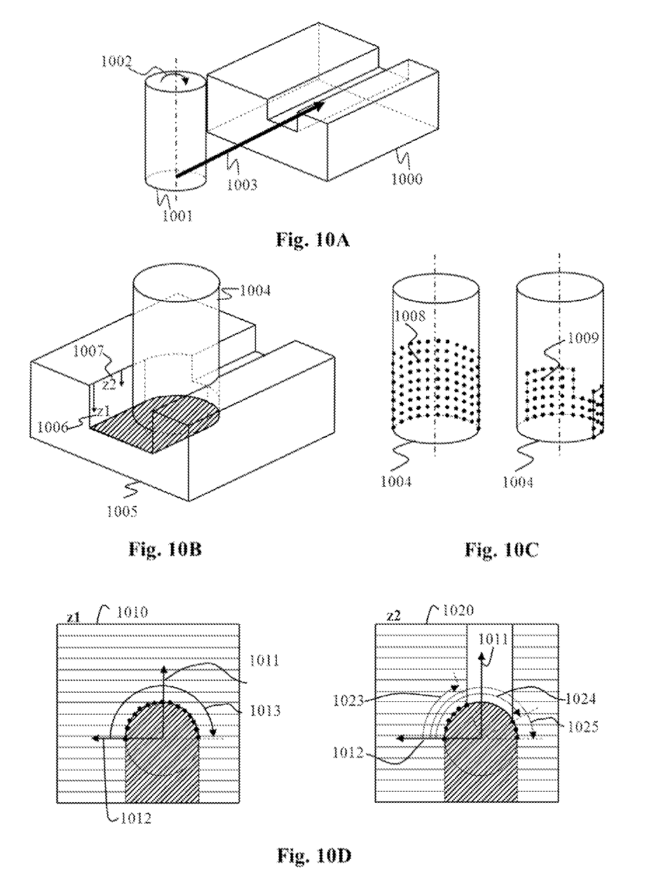

FIG. 10A shows an embodiment simulating the flat-end mill tool 1001 rotating in clockwise direction 1002, moving along a straight tool path 1003, and removing some material from the workpiece 1000.

FIG. 10B shows the in-process workpiece 1005 and the current instance of the tool 1004. Since the front face of the tool is in contact with the in-process workpiece, the set of points 1008 are arranged only on the front face part of the tool 1004, as shown in FIG. 10C. After determination of a distance between each point in the set of points 1008 and a surface of the workpiece 1005 modified by the motion of the tool, a subset of points 1009 are determined to form the engagement surface 727.

Some embodiments determine an area and an angle of the engagement between the tool and the workpiece based on the engagement surface. For example, one embodiment determines the angle of engagement by using an arctangent function of a tangent tool path vector 1011 and a normal vector 1012. The entry and exit angles of engagement are defined in clockwise direction and measured from the normal vector and where the entry angle is the angle at which the tool begins cutting the workpiece and the exit angle is the angle at which the tool stops cutting the workpiece. For given depths 1006 and 1007, the cross sections 1010 and 1020 of the in-process workpiece are respectively shown in FIG. 10D. The entry angle, exit angle and angle of engagement 1013 are 0, 180 and 180 deg. respectively for the cross section 1010 at the depth z1.

During an instant of the simulation, the engagement surface can have one or multiple pairs of entry and exit angles. At the depth z1 1006, the angle of engagement 1013 includes one pair of entry and exit angles, however for the depth z2 1007 and the angle of engagement includes two pairs of entry and exit angles. In the first pair the tool enters the workpiece at 0° and exits at 70° 1023, and in the second pair the tool enters the workpiece at 150° 1024 and exits at 180° 1025. In this example, although the engagement surface is a single surface, different number of pair of entry and exit angles exists for different cross-sections. Also, in various embodiments, the area of the engagement is determined based of a shape of the parts of the engagement surface using appropriate mathematical principles:

Some embodiments use the engagement surface, the angle of the engagement and depths of the tool to calculate the instantaneous milling forces in, e.g., the radial, tangential, and feed directions. Without the knowledge of the engagement surface, the computation of the milling forces is difficult. Additionally or alternatively, some embodiments determine process parameters by calculating the axial and radial depths and cut or uncut chip thickness.

Some embodiments determine the engagement surface for geometric motions of the tool. Additionally, small deflections between the tool and workpiece can be considered. However, the path of motion of the tool can be is altered when the tool undergoes dynamic displacements where chatter vibration plays an important role in the mechanics of the machining process. In this case, the updated tool path having the dynamic displacements is used to determine the engagement surface. Various embodiments of the invention can be adapted to all physical conditions influencing an accurate representation of an in-process workpiece during simulation.

Operating Environment

Various embodiments of the invention can be operated by numerous general purpose or special purpose computing system environments or configurations. Examples of well known computing systems, environments, and/or configurations that are suitable for use with the invention include, but are not limited to, personal computers, server computers, handheld or laptop devices, multiprocessor or multi-core systems, graphics processing units (GPUs), application-specific integrated circuits (ASICs), field programmable gate arrays (FPGAs), microcontroller-based systems, network PCs, mainframe computers, distributed computing environments that include any of the above systems or devices, and the like, i.e., generally processors.

For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format. A monitor or other type of display device 160 is connected to any of the above systems to enable visualization 162 of the invention.

Further, it should be appreciated that a computer may be embodied in any of a number of forms, such as a rack-mounted computer, a desktop computer, a laptop computer, minicomputer, or a tablet computer. Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory computer-readable medium or multiple computer readable media, e.g., a computer memory, compact discs (CD), optical discs, digital video disks (DVD), magnetic tapes, and flash memories. The terms “program” or “software” are used herein in a generic sense to refer to any type of computer code or set of computer-executable instructions that can be employed to program a computer or other processor to implement various aspects of the present invention as discussed above.

Computer-executable instructions may be in many forms, such as program modules, executed by one or more computers or other devices. Generally, program modules include routines, programs, objects, components, data structures that perform particular tasks or implement particular abstract data types. Typically the functionality of the program modules may be combined or distributed as desired in various embodiments.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

1. A method for determining an engagement surface between a tool and a workpiece during a simulation of a machining the workpiece by a relative motion between the tool and the workpiece, comprising the steps of:
arranging a set of points on at least a part of a surface of the tool;
determining a distance between each point in the set of points and a surface of the workpiece modified by the motion; and
forming the engagement surface based on a subset of the points having the distance less than a threshold, wherein the steps of the method are performed by a processor.

2. The method of claim 1, wherein the workpiece is represented by a composite adaptively sampled distance filed (CADF), further comprising:
determining a distance field of a swept volume formed by the motion from an initial position of the tool to a current position of the tool; and
modifying the CADF by the distance field of the swept volume to represent an in-process workpiece having the surface modified by the motion.

3. The method of claim 2, wherein the steps of the method are performed iteratively until the tool reaches a final position of the simulation.

4. The method of claim 1, further comprising:
determining an area of engagement between the tool and the workpiece based on the engagement surface.

5. The method of claim 1, further comprising:
determining an angle of engagement between the tool and the workpiece based on the engagement surface.

6. The method of claim 1, further comprising:
arranging the set of points according to a regularly spaced sampling pattern in a cylindrical coordinate system, such that the points in the set of points are equally spaced in an angle within equally spaced planes perpendicular to an axis of the tool.

7. The method of claim 1, further comprising:
arranging the set of points according to a regularly spaced sampling pattern in a spherical coordinate system, such that the points in the set of points are equally spaced in an azimuth angle within equally spaced planes in an elevation angle.

8. The method of claim 1, further comprising:
arranging the set of points according to a geodesic pattern in which curves follow through a boundary circumscribing a regular polyhedron with triangular faces, such that the points are arranged on vertices of the triangular faces.

9. The method of claim 1, further comprising:
arranging the set of points according to a sampling pattern selected based on a shape of the tool.

10. The method of claim 1, further comprising:
arranging the set of points according to a sampling pattern having a varying density of the points.

11. The method of claim 1, further comprising:
determining a milling force of the tool using the engagement surface.

12. A method for determining an engagement between a tool and an object during a simulation of a machining of the object, wherein the object is represented by an object distance field, the tool is represented by a tool distance field, and a motion between the object and the tool is represented by a swept volume distance field, comprising the steps of:
arranging a set of points on at least a part of the surface of the tool using the tool distance field;
determining a distance between each point in the set of points and the surface of the object modified by the swept volume using at least one of the object, tool, or the swept volume distance field; and
forming the engagement surface based on a subset of points having the distance below a threshold, wherein the steps of the method are performed by a processor.

13. A system for analyzing an engagement between a tool and a workpiece during a simulation of a machining of the workpiece by a motion of the tool according to a path, wherein the workpiece is represented by a model of the workpiece including an object distance field defining a surface of the workpiece, the tool is represented by a model of the tool including a tool distance field defining a surface of the tool, and the motion is represented by at least one swept volume including a swept volume distance field defining a surface of the swept volume, the path is represented by a parametric function, comprising:
a processor for determining an engagement surface formed by the tool intersecting the workpiece at a instant of the simulation based on distance values between a set of points arranged on the surface of the tool and a surface of an in-process workpiece defined by the object distance field modified by the swept volume distance field at the instant of the simulation.

14. The system of claim 13, wherein the processor determines an area of engagement between the tool and the workpiece based on the engagement surface.

15. The system of claim 13, wherein the processor determines an angle of engagement between the tool and the workpiece based on the engagement surface.
